(19) United States
(12) Patent Application Publication
(10) Pub. No.: US 2026/0054477 A1
(43) Pub. Date: Feb. 26, 2026

(54) LIQUID EJECTION APPARATUS AND CONTROL METHOD

(71) Applicant: CANON KABUSHIKI KAISHA, Tokyo (JP)

(72) Inventors: YURIKA KUROGI, Tokyo (JP); YOSHIHIRO HAMADA, Kanagawa (JP); FUMI TANAKA, Kanagawa (JP); YUZURU ISHIDA, Kanagawa (JP); KOICHI ISHIDA, Tokyo (JP); KEIJI TOMIZAWA, Kanagawa (JP); SHUZO IWANAGA, Kanagawa (JP); YUJI NUKUI, Kanagawa (JP); YUGO YAMAMOTO, Kanagawa (JP)

(21) Appl. No.: 19/289,444

(22) Filed: Aug. 4, 2025

(30) Foreign Application Priority Data
Aug. 21, 2024 (JP) 2024-139904

(51) Int. Cl. B41J 2/045; B41J 2/14

(52) U.S. Cl. CPC B41J 2/04513; B41J 2/14

(57) ABSTRACT

Provided is a technique capable of obtaining stable ejection characteristics. For this purpose, as a potential difference between an electrode 121 and a counter electrode 129 in an aging process, different potential differences ΔVa are used for a brand-new liquid ejection head and a liquid ejection head having undergone a kogation removal operation.

### BACKGROUND

### Field of the Technology

The present disclosure relates to a liquid ejection apparatus and a control method.

### Description of the Related Art

Some liquid ejection apparatuses configured to perform printing by ejecting liquids such as inks from a liquid ejection head employ, as a method of generating energy for liquid ejection, a method of heating the inks with heating resistors (hereinafter also referred to as “heaters”), thereby generating bubbles and ejecting the inks. In the case of the above method of ejecting the inks with heating by the heaters, the heaters heat the inks, thereby generating kogation of the inks on the surfaces of the heaters, which results in a change in the ejection velocity. The inks used in such a liquid ejection apparatus are often inks containing dye-based or pigment-based coloring materials, and most of these coloring materials are insoluble or poorly soluble in water. These insoluble or poorly soluble coloring materials are thought to be one of the causes for kogation.

It is known that, in a case where inks prone to kogation as described above are ejected in a state having almost no kogation such as a state immediately after a brand-new liquid ejection head is mounted, ejection characteristics change (an ejection velocity decreases) as a result of the generation of kogation on the surfaces of heating portions at which the heaters are located (hereinafter also simply referred to as the heater surfaces).

To address this, a kogation removal method is performed by causing electrochemical reactions with the inks to dissolve the heater surfaces, thereby removing kogation.

However, it is recognized that, in a case where a certain amount of ejection operations is executed from a state having almost no kogation, the ejection characteristics change more greatly than in a case where the above certain amount of ejection operations is executed from a state having a certain degree of kogation. This gives rise to a new problem in that such a great change in the ejection characteristics may affect outputs such as images.

Japanese Patent Laid-Open No. 2014-131867 proposes performing a preliminary ink ejection process (hereinafter also referred to as aging), which will not contribute to printing on paper surfaces, in advance before printing on the paper surfaces. Through the aging, a certain degree of kogation is attached to electrode surfaces to make the kogation uniform, thereby stabilizing the electrode surfaces to suppress a change in the ejection characteristics.

However, for example, the heater surfaces in a liquid ejection head in an initial stage of use and the heater surfaces after the kogation removal process are different in the state of the surface layers. For this reason, in the case where the aging is performed under the same conditions regardless of the state of the liquid ejection head as in Japanese Patent Laid-Open No. 2014-131867, the ejection characteristics after the aging may vary depending on the state of the liquid ejection head.

### SUMMARY OF THE INVENTION

Therefore, the present disclosure provides a technique capable of obtaining stable ejection characteristics regardless of a state of a liquid ejection head.

For this purpose, a liquid ejection apparatus in the present disclosure is a liquid ejection apparatus on which an ejection unit is mountable, the ejection unit including a heating resistor configured to generate heat with power supply, thereby generating energy for ejecting a liquid, a first electrode provided in a protective portion that covers and protects the heating resistor, and a second electrode capable of electrically connecting with the first electrode via the liquid, the liquid ejection apparatus including a control unit configured to control the mounted ejection unit. The control unit is capable of executing an aging process of causing the ejection unit to eject the liquid, thereby accumulating kogation on the first electrode, and a kogation removal process of applying a voltage between the first electrode and the second electrode, thereby dissolving a surface of the first electrode into the liquid and removing the accumulated kogation. In the aging process, the control unit sets, as a potential difference applied between the first electrode and the second electrode, different potential differences in a case where the ejection unit has undergone the kogation removal process and a case where the ejection unit is yet to undergo the kogation removal process.

According to the present disclosure, it is possible to provide a technique capable of obtaining stable ejection characteristics.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a schematic structure of a liquid ejection apparatus;

FIG. 2 is a block diagram illustrating a configuration of a printing apparatus;

FIG. 3 is a schematic diagram illustrating a first circulation path as one mode of a circulation path;

FIG. 4 is a schematic diagram illustrating a second circulation path;

FIGS. 5A and 5B are perspective views of a liquid ejection head;

FIG. 6 is an exploded perspective view of components or units constituting the liquid ejection head;

FIGS. 7A to 7F are views illustrating front surfaces and back surfaces of first to third channel members;

FIG. 8 is a see-through view seen from the surface of the first channel member on which ejection modules are mounted;

FIG. 9 is a view illustrating a cross section taken along a line IX-IX in FIG. 8;

FIGS. 10A and 10B are perspective views illustrating an ejection module;

FIGS. 11A to 11C are plan views of a print element board;

FIG. 12 is a perspective view illustrating a cross section of a print element board and a lid member;

FIG. 13 is an enlarged plan view partially illustrating adjacent portions of print element boards;

FIGS. 14A and 14B are diagrams illustrating an area near a heating portion in a print element board;

FIGS. 15A to 15C are schematic diagrams presenting a kogation suppression process for negatively charged particles;

FIG. 16 is a graph showing a relationship between an ejection velocity and a potential difference; and

FIGS. 17A and 17B are schematic diagrams illustrating a kogation suppression process for positively charged particles.

### DESCRIPTION OF THE EMBODIMENTS

Hereinafter, a first embodiment of the present disclosure will be described in reference to the drawings.

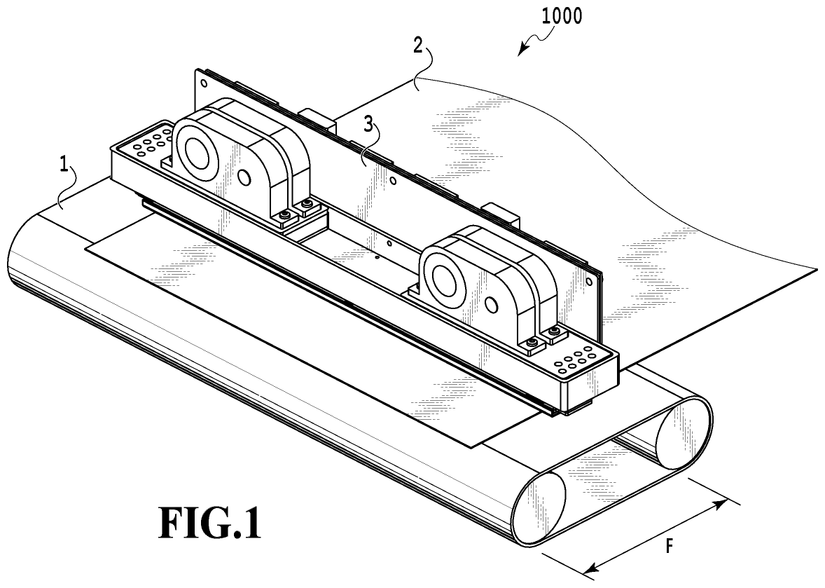

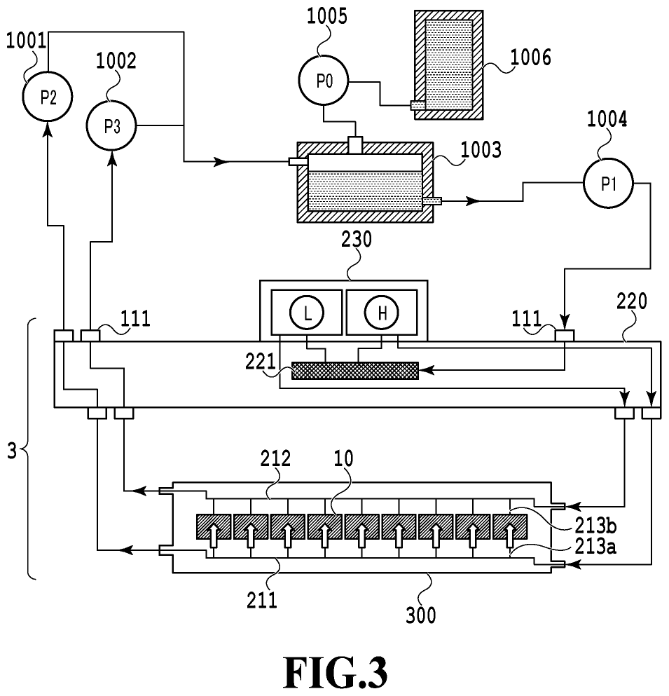

FIG. 1 is a view illustrating a schematic structure of a liquid ejection apparatus (also referred to as a printing apparatus) 1000 according to the present embodiment. The printing apparatus 1000 is a line-type printing apparatus including a conveyor unit 1 configured to convey a print medium 2 and a line-type liquid ejection head 3 arranged substantially orthogonal to a print medium conveyance direction. The line-type printing apparatus performs continuous printing by one pass while continuously or intermittently conveying multiple print media 2. The print medium 2 is not limited to a cut sheet, but may be continuous roll paper. The liquid ejection head 3 is capable of performing full-color printing with liquid cyan, magenta, yellow, and black (CMYK) inks. One liquid ejection head 3 may support one color or multiple colors. The liquid ejection head 3 is mounted on the printing apparatus 1000 in a replaceable manner. The liquid ejection head 3 is fluidly connected to a liquid supply system constituting a supply path for supplying each of the inks to the liquid ejection head 3, an ink cartridge 1006 serving as a main tank, and a buffer tank 1003 (see FIG. 3), as described later. Furthermore, a power controller configured to transmit power and ejection control signals to the liquid ejection head 3 is electrically connected to the liquid ejection head 3. A liquid path and an electric signal path in the liquid ejection head 3 are described later. The printing apparatus 1000 circulates the inks via the liquid ejection head 3.

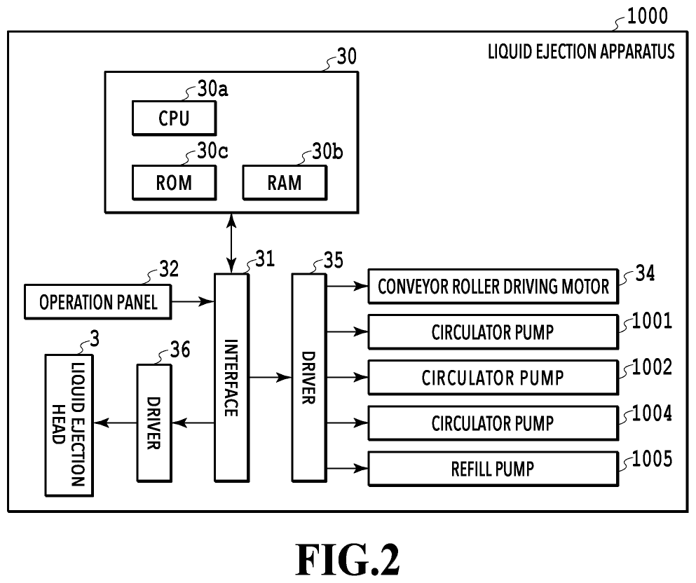

FIG. 2 is a block diagram illustrating a configuration of the printing apparatus 1000. The printing apparatus 1000 includes a control unit 30 including a CPU 30a such as a microprocessor and a RAM 30b which is used as a work area of the CPU 30a and which, for example, stores various kinds of data such as print data and registration adjustment values. The control unit 30 includes a ROM 30c which stores a control program of the CPU 30a and various kinds of data. Moreover, the printing apparatus 1000 includes an interface 31, an operation panel 32, and drivers 35 and 36. The driver 35 drives and controls a conveyor roller driving motor 34 and circulator pumps 1001, 1002, and 1004 and a refill pump 1005, which are provided to an ink supply channel. The driver 36 drives the liquid ejection head 3.

Print data received by the printing apparatus 1000 is stored in the RAM 30b of the control unit 30. According to the print data stored in the RAM 30b, the control unit 30 outputs ON/OFF signals for driving the motor 34 to the driver 35 and outputs ejection signals and so on to the driver 36, thereby forming an image on a print medium. Moreover, according to a control sequence to be described later, the control unit 30 outputs a signal for driving the circulator pump 1002 to the driver 35, thereby controlling the circulator pump 1002.

FIG. 3 is a schematic diagram illustrating a first circulation path as one mode of a circulation path applied to the printing apparatus according to the present embodiment. As illustrated in FIG. 3, the liquid ejection head 3 is fluidly connected to two first circulator pumps 1001 (high pressure side) and 1002 (low pressure side), the buffer tank 1003, and so on. Although FIG. 3 only illustrates the path in which only one color of ink among the CMYK inks circulates for simplification of description, circulation paths for the four colors are actually provided in the liquid ejection head 3 and a printing apparatus main body.

The printing apparatus 100 includes the buffer tank 1003 as a subtank to which an ink cartridge 1006 containing the ink is attachable and which is connected to the ink cartridge 1006. The buffer tank 1003 includes an air communication hole (not illustrated) through which the inside and the outside of the buffer tank 1003 communicate with each other and is capable of discharging air bubbles in the ink to the outside. The buffer tank 1003 is also connected to the refill pump 1005. As the ink is consumed by the liquid ejection head 3, the refill pump 1005 transfers the consumed volume of the ink from the ink cartridge 1006 to the buffer tank 1003. For example, the ink is consumed by the liquid ejection head 3 in a case where the ink is ejected (discharged) from ejection orifices of the liquid ejection head for printing with ink ejection, suction recovery, or the like.

The two first circulator pumps 1001 and 1002 have the role of sucking the ink from liquid connection portions 111 of the liquid ejection head 3 and delivering the ink to the buffer tank 1003. The first circulator pumps 1001 and 1002 are preferably positive displacement pumps each having a capacity of delivering a fixed volume of liquid. Specifically, the first circulator pumps 1001 and 1002 may be tube pumps, gear pumps, diaphragm pumps, syringe pumps, and so on. Instead, for example, a pump equipped with a general constant flow valve or relief valve installed at the pump outlet to ensure a constant flow rate may be used. During driving of the liquid ejection head 3, the first circulator pump (high pressure side) 1001 and the first circulator pump (low pressure side) 1002 cause a certain fixed volume of the ink to flow in each of a common supply channel 211 and a common collection channel 212. This flow rate is preferably set to equal to or higher than such a flow rate that the temperature difference among print element boards 10 in the liquid ejection head 3 will not affect the quality of printed images. However, in the case where too high a flow rate is set, a negative pressure difference among the print element boards 10 becomes too large due to pressure drops in channels inside a liquid ejection unit 300, resulting in uneven density in an image. For this reason, it is preferable to set the flow rate with the temperature difference and the negative pressure difference among the print element boards 10 taken into consideration.

A negative pressure control unit 230 is provided in the middle of a path connecting the second circulator pump 1004 and the liquid ejection unit 300. The negative pressure control unit 230 has a function to operate to maintain the pressure on the side downstream of the negative pressure control unit 230 (in other words, on the liquid ejection unit 300 side) at a preset constant pressure even in a case where the flow rate in a circulation system varies due to a change in the duty for printing. Two pressure regulation mechanisms constituting the negative pressure control unit 230 may be any mechanisms capable of controlling the pressure on the side downstream of them within a certain fluctuation range centered on a desired set pressure. As an example, a mechanism similar to a so-called “pressure reducing regulator” may be employed. In the case where pressure reducing regulators are used, it is preferable that the second circulator pump 1004 apply a pressure to the side upstream of the negative pressure control unit 230 via a liquid supply unit 220. Since this structure can reduce an influence of a water head pressure of the buffer tank 1003 on the liquid ejection head 3, the degree of freedom in the layout of the buffer tank 1003 in the printing apparatus 1000 can be increased. The second circulator pump 1004 may be any pump having a pump head pressure equal to or higher than a certain pressure under condition within a range of an ink circulation flow rate to be used during driving of the liquid ejection head 3, and may be a turbo pump, a positive displacement pump, or the like. Specifically, a diaphragm pump or the like may be used. Instead of the second circulator pump 1004, for example, a water head tank positioned with a certain water head difference from the negative pressure control unit 230 may be used.

As illustrated in FIG. 3, the negative pressure control unit 230 includes the two pressure regulation mechanisms which are set with different control pressures. Of the two pressure regulation mechanisms, the pressure regulation mechanism set with a relatively high pressure (denoted by H in FIG. 3) is connected to the common supply channel 211 of the liquid ejection unit 300 via the liquid supply unit 220. Meanwhile, the pressure regulation mechanism set with a relatively low pressure (denoted by L in FIG. 3) is connected to the common collection channel 212 via the liquid supply unit 220.

The liquid ejection unit 300 is provided with the common supply channel 211 and the common collection channel 212 as well as dedicated supply channels 213a and dedicated collection channels 214b which communicate with the respective print element boards 10. The dedicated supply channels 213a communicate with the common supply channel 211, while the dedicated collection channels 214b communicate with the common collection channel 212. This structure generates flows (arrows in FIG. 3) in which portions of the ink flow from the common supply channel 211 to the common collection channel 212 through internal channels of the print element boards 10. This is because the structure in which the pressure regulation mechanism H is connected to the common supply channel 211 and the pressure regulation mechanism L is connected to the common collection channel 212 generates a differential pressure between these two common channels.

In this way, in the liquid ejection unit 300, flows are generated such that the ink passes through the insides of the common supply channel 211 and the common collection channel 212 and portions of the ink pass through the insides of the print element boards 10. Thus, the heat generated in each of the print element boards 10 can be released to the outside of the print element board 10 with the flows passing through the common supply channel 211 and the common collection channel 212. In addition, this structure makes it possible to generate flows of the ink also in the ejection orifices and the pressure chambers which are not engaged in printing during printing by the liquid ejection head 3, thereby preventing the thickening of the ink in those areas. Moreover, this structure can also discharge the thickened ink and foreign substances contained in the ink to the common collection channel 212. Therefore, the liquid ejection head 3 in the present embodiment is capable of achieving high-speed and high-quality printing.

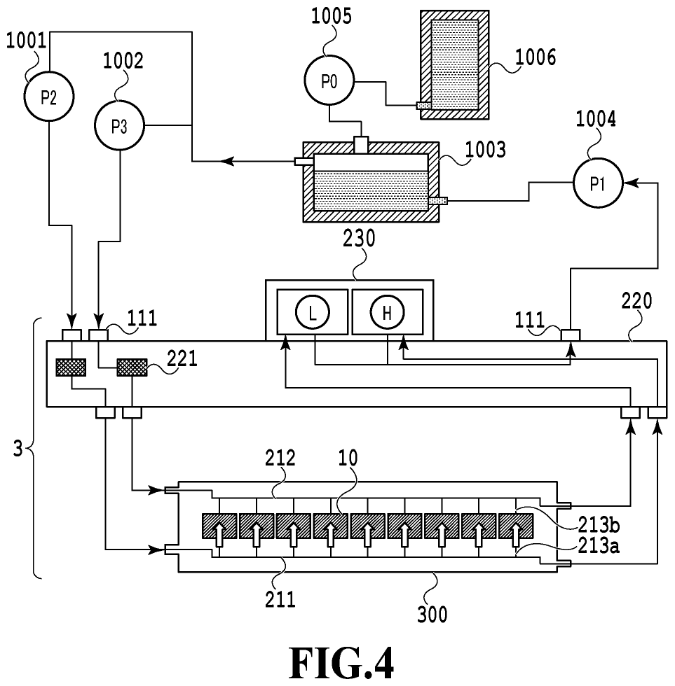

FIG. 4 is a schematic diagram illustrating a second circulation path different from the aforementioned first circulation path among circulation paths applied to the printing apparatus 1000 according to the present embodiment. Main differences from the first circulation path are as follows.

First, each of two pressure regulation mechanisms constituting the negative pressure control unit 230 has a mechanism capable of controlling the pressure on the side upstream of the negative pressure control unit 230 within a certain fluctuation range centered on a desired set pressure (a mechanical component to act in the same way as a so-called “back pressure regulator”). Second, the second circulator pump 1004 acts as a negative pressure source to reduce the pressure on the side downstream of the negative pressure control unit 230. Third, the first circulator pump (high pressure side) 1001 and the first circulator pump (low pressure side) 1002 are arranged upstream of the liquid ejection head 3, while the negative pressure control unit 230 is arranged downstream of the liquid ejection head 3.

In the second circulation path, the negative pressure control unit 230 operates during printing by the liquid ejection head 3 such that pressure fluctuations on the side upstream of the negative pressure control unit 230 (in other words, the liquid ejection unit 300 side) may be kept within a certain range even if the flow rate varies due to a change in the duty for printing. The pressure fluctuations are kept, for example, within a certain range centered on a preset pressure. As illustrated in FIG. 4, it is preferable that the second circulator pump 1004 pressurize the side downstream of the negative pressure control unit 230 via the liquid supply unit 220. Since this structure can reduce an influence of a water head pressure of the buffer tank 1003 on the liquid ejection head 3, the degree of freedom in the layout of the buffer tank 1003 in the printing apparatus 1000 can be increased. Instead of the second circulator pump 1004, for example, a water head tank positioned with a certain water head difference from the negative pressure control unit 230 may be used.

As similar to the first circulation path, the negative pressure control unit 230 illustrated in FIG. 4 includes the two pressure regulation mechanisms which are set with different control pressures. Of the two pressure regulation mechanisms, the pressure regulation mechanism set with a relatively high pressure (denoted by H in FIG. 4) is connected to the common supply channel 211 of the liquid ejection unit 300 via the liquid supply unit 220. Meanwhile, the pressure regulation mechanism set with a relatively low pressure (denoted by L in FIG. 4) is connected to the common collection channel 212 via the liquid supply unit 220.

With the two pressure regulation mechanisms, the pressure in the common supply channel 211 is made higher than the pressure in the common collection channel 212. This structure generates the ink flows from the common supply channel 211 to the common collection channel 212 through the dedicated supply channels 213 and the internal channels of the print element boards 10 (arrows in FIG. 4). Although the second circulation path thus generates, in the liquid ejection unit 300, the same ink flows as in the first circulation path, the second circulation path has two advantages over the first circulation path.

The first advantage is that since the negative pressure control unit 230 is arranged downstream of the liquid ejection head 3 in the second circulation path, there is less concern that dust or foreign substances generated in the negative pressure control unit 230 will flow into the liquid ejection head 3. The second advantage is that the maximum value of the necessary flow volume to be supplied from the buffer tank 1003 to the liquid ejection head 3 in the second circulation path can be smaller than in the first circulation path, for the following reason. Here, the total flow volume in the common supply channel 211 and the common collection channel 212 in the ink circulation during standby for printing is defined as A. The value A is defined as a minimum flow volume necessary to control temperature differences in the liquid ejection unit 300 within a desired range in the case where the temperature regulation in the liquid ejection head 3 is performed during standby for printing. In addition, the ejection flow volume required to eject the ink from all the ejection orifices of the liquid ejection unit 300 (full ejection) is defined as F. In the case of the first circulation path (see FIG. 3), since the total value of the set flow volumes of the first circulator pump (high pressure side) 1001 and the first circulator pump (low pressure side) 1002 is A, the maximum value of the necessary liquid supply volume to the liquid ejection head 3 for the full ejection is A+F.

On the other hand, in the case of the second circulation path (see FIG. 4), the necessary liquid supply volume to the liquid ejection head 3 during standby for printing is the flow volume A. Then, the necessary liquid supply volume to the liquid ejection head 3 for the full ejection is the flow volume F. Thus, in the case of the second circulation path, the total value of the set flow volumes of the first circulator pump (high pressure side) 1001 and the first circulator pump (low pressure side) 1002, that is, the maximum value of the necessary liquid supply volume is a larger value of A and F. For this reason, as long as the liquid ejection unit 300 with the same structure is used, the maximum value (A or F) of the necessary liquid supply volume in the second circulation path is always smaller than the maximum value (A+F) of the necessary liquid supply volume in the first circulation path. Accordingly, in the case of the second circulation path, the degree of freedom of an applicable circulator pump is increased. Thus, there is an advantage in that the cost of the printing apparatus main body can be reduced because a simple low-cost circulator pump can be used and the load on a cooler (not illustrated) installed in a main body path can be reduced. This advantage is significant for a line head having a relatively large value A or F and is more significant as the longitudinal length of a line head becomes longer.

However, the first circulation path also has an advantage over the second circulation path. Specifically, in the second circulation path, the flow volume in the liquid ejection unit 300 during standby for printing is at its maximum, so that the lower the duty for printing, the higher the negative pressure applied to each ejection orifice. For this reason, particularly in a case where the channel widths (lengths in the direction perpendicular to the ink flow direction) of the common supply channel 211 and the common collection channel 212 are reduced and the head width (length in the short direction of the liquid ejection head) is reduced, a high negative pressure is applied to the ejection orifices for low-duty images in which unevenness is more noticeable. The application of such a high negative pressure may increase the influence of satellite droplets. On the other hand, in the case of the first circulation path, a high negative pressure is applied to the ejection orifices at timing of forming high-duty images, which is advantageous in that satellites, even if occur, are less noticeable and have little influence on the printed images. From the two circulation paths, a preferable circulation path may be selected in light of the specifications of the liquid ejection head and the printing apparatus main body (the ejection flow volume F, the minimum circulation flow volume A, and the channel flow resistance in the head).

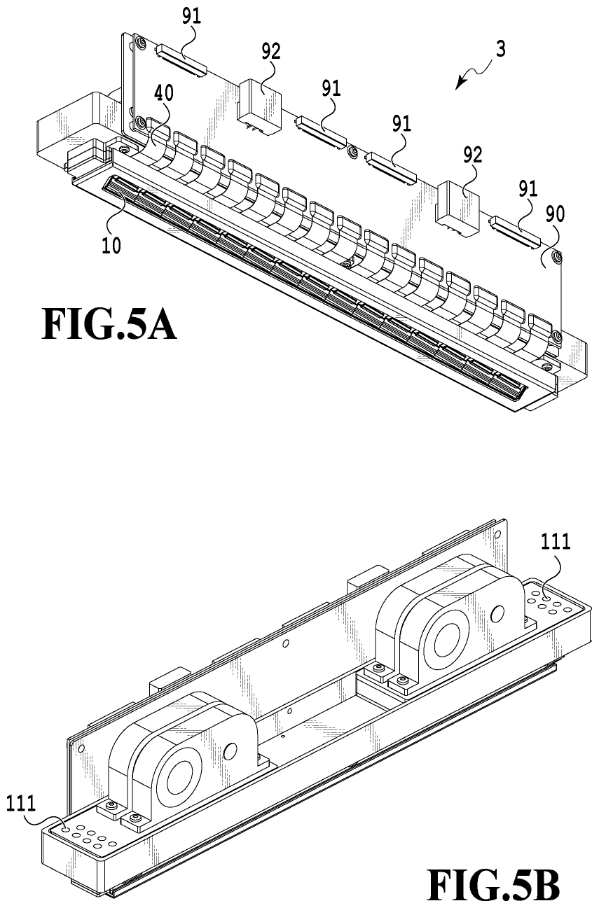

FIGS. 5A and 5B are perspective views of the liquid ejection head 3. The following description of FIGS. 5A to 13 is given of a mode in which one liquid ejection head ejects four colors of inks. As illustrated in FIG. 5A, the liquid ejection head 3 includes the print element boards 10 as well as signal input terminals 91 and power supply terminals 92 which are connected to the print element boards 10 via flexible wiring boards 40 and an electric wiring board 90. The signal input terminals 91 and the power supply terminals 92 are electrically connected to the control unit 30 of the printing apparatus 1000. Ejection drive signals are supplied to the print element boards 10 via the signal input terminals 91 and power necessary for ejection is supplied to the print element boards 10 via the power supply terminals 92.

The wiring lines are consolidated by using electric circuits in the electric wiring board 90, so that the number of the signal input terminals 91 and the number of the power supply terminals 92 can be made smaller than the number of the print element boards 10. This reduces the number of electrical connection points which need to be connected in mounting the liquid ejection head 3 onto the printing apparatus 1000 or to be disconnected in replacing the liquid ejection head 3. As illustrated in FIG. 5B, the liquid connection portions 111 provided on both end sides of the liquid ejection head 3 are connected to the liquid supply system of the printing apparatus 1000. Through these portions, the four CMYK colors of inks are supplied from the supply system of the printing apparatus 1000 to the liquid ejection head 3 and the inks after passing through the liquid ejection head 3 are returned to the supply system of the printing apparatus 1000. In this way, these colors of inks can be circulated via paths of the printing apparatus 1000 and paths of the liquid ejection head 3.

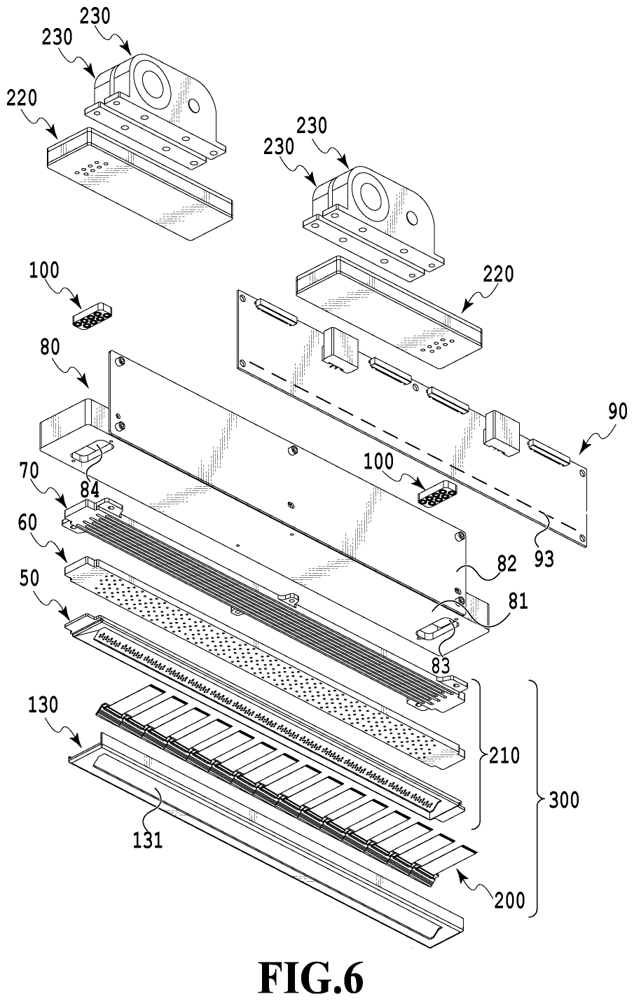

FIG. 6 is an exploded perspective view of components or units constituting the liquid ejection head 3. The liquid ejection unit 300, the liquid supply units 220, and the electric wiring board 90 are attached to a casing 80. The liquid supply units 220 are provided with the liquid connection portions 111 (see FIGS. 3 to 5). Inside the liquid supply units 220, filters 221 for the respective colors (see FIGS. 3 and 4) are provided which communicate with openings of the liquid connection portion 111 in order to remove foreign substances from the inks to be supplied. Each of the two liquid supply units 220 is provided with the filters 221 for two colors. The inks after passing through the filters 221 are supplied to the negative pressure control units 230 for the respective colors arranged on the liquid supply units 220.

The negative pressure control unit 230 is a unit for each color including a pressure regulator valve. By actions of valves, spring members, and so on provided inside the negative pressure control unit 230, the negative pressure control unit 230 significantly attenuates a pressure drop change that occurs with a fluctuation of the ink flow rate in the supply system of the printing apparatus 1000 (the supply system upstream of the liquid ejection head 3). For this reason, the negative pressure control unit 230 is capable of stabilizing a negative pressure change within a certain range on the side downstream of the negative pressure control unit 230 (on the liquid ejection unit 300 side). The negative pressure control unit 230 for each color internally includes the two pressure regulator valves for the above color as described with reference to FIG. 3. These pressure regulator valves are set with different control pressures. The valve on the high pressure side communicates with the common supply channel 211 and the valve on the low pressure side communicates with the common collection channel 212 in the liquid ejection unit 300 via the liquid supply unit 220.

The casing 80 includes a liquid ejection unit support portion 81 and an electric wiring board support portion 82, and ensures the stiffness of the liquid ejection head 3 while supporting the liquid ejection unit 300 and the electric wiring board 90. The electric wiring board support portion 82 is for supporting the electric wiring board 90 and is fixed to the liquid ejection unit support portion 81 with screws. The liquid ejection unit support portion 81 has a role of ensuring the accuracy of the relative positions of the multiple print element boards 10 by correcting warping and deformation of the liquid ejection unit 300, thereby suppressing streaks and unevenness on printed products. For this purpose the liquid ejection unit support portion 81 preferably has sufficient stiffness, and a preferable material therefor is a metal material such as SUS or aluminum or ceramic such as alumina. The liquid ejection unit support portion 81 is provided with openings 83 and 84 into which joint rubbers 100 are inserted. The inks supplied from liquid supply units 220 are guided via the joint rubbers 100 to a third channel member 70 included in the liquid ejection unit 300.

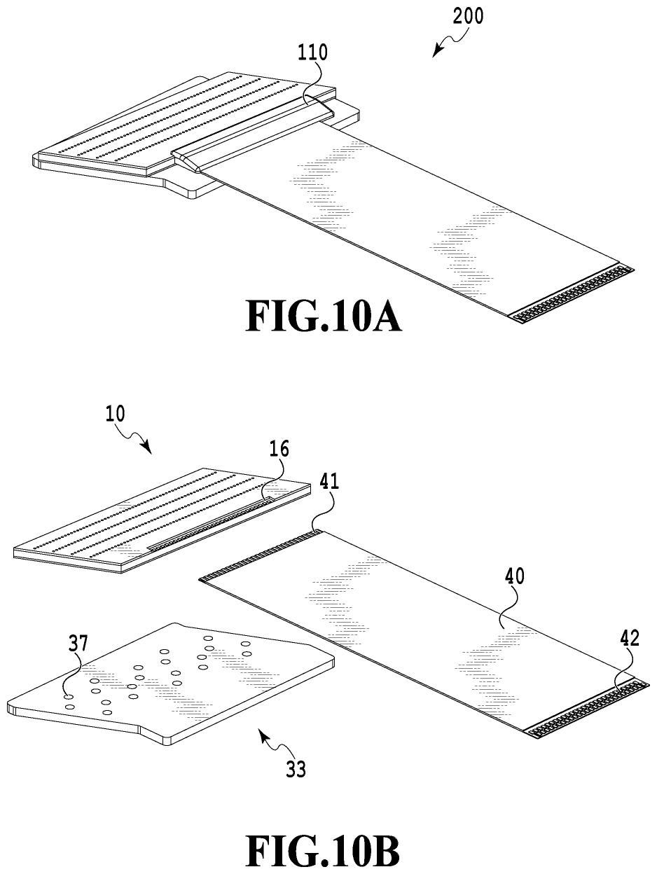

The liquid ejection unit 300 includes multiple ejection modules 200 and a channel member 210. A cover member 130 is attached to a surface of the liquid ejection unit 300 on a print medium side. The cover member 130 is a member having a frame-shaped surface provided with a long opening 131, and the print element boards 10 and seal members 110 (see FIG. 10A) included in the ejection modules 200 are exposed from the opening 131. The frame portion around the opening 131 functions as a contact surface to come into contact with a capping member configured to cap the liquid ejection head 3 during standby for printing. For this purpose, it is preferable to apply an adhesive, a sealant, a filler, or the like along the periphery of the opening 131 to fill in irregularities and gaps on the ejection orifice surface of the liquid ejection unit 300 so that a closed space is formed in a state where the liquid ejection unit 300 is capped.

Next, a structure of the channel member 210 included in the liquid ejection unit 300 is described. As illustrated in FIG. 6, the channel member 210 is formed by stacking a first channel member 50, a second channel member 60, and the third channel member 70. The channel member 210 distributes the inks supplied from the liquid supply units 220 to the ejection modules 200, and also returns the inks circulating from the ejection modules 200 to the liquid supply units 220. The channel member 210 is fixed to the liquid ejection unit support portion 81 with screws, which suppresses warping or deformation of the channel member 210.

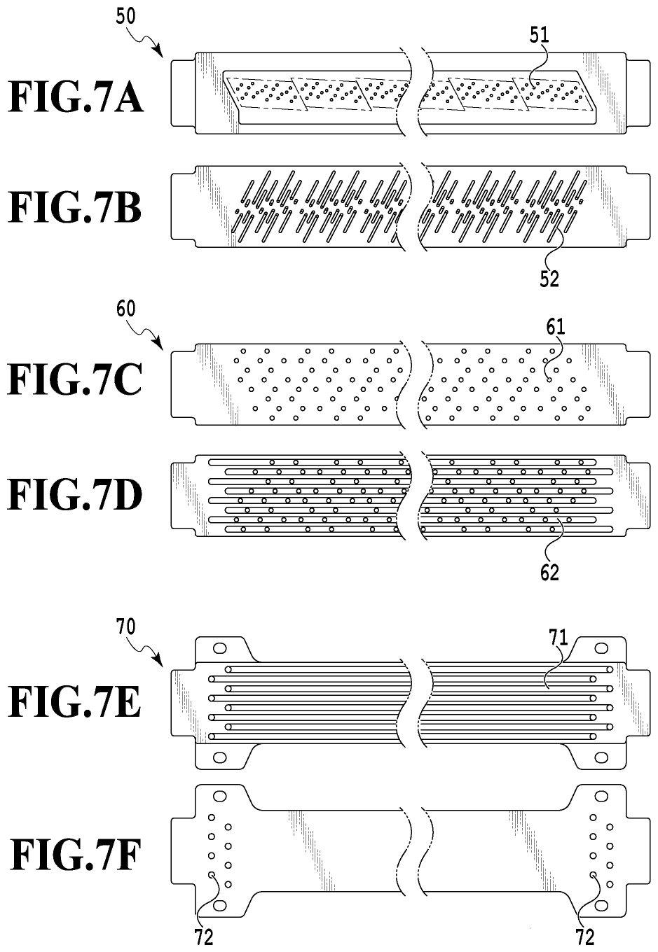

FIGS. 7A to 7F are views illustrating front surfaces and back surfaces of the first to third channel members. FIG. 7A illustrates a surface of the first channel member 50 on which the ejection modules 200 are mounted, whereas FIG. 7F illustrates a surface of the third channel member 70 in contact with the liquid ejection unit support portion 81. The first channel member 50 and the second channel member 60 are joined so that the contact surfaces of these channel members 50 and 60, that is, the surfaces illustrated in FIGS. 7B and 7C face each other. The second channel member 60 and the third channel member 70 are joined so that the contact surfaces of these channel members 60 and 70, that is, the surfaces presented in FIGS. 7D and 7E face each other. With the second channel member 60 and the third channel member 70 joined, common channel grooves 62 formed in the second channel member 60 and common channel grooves 71 formed in the third channel member 70 form eight common channels extending in a longitudinal direction of the channel members. Thus, as illustrated in FIGS. 7A to 7F, for each color, a set of the common supply channel 211 and the common collection channel 212 is formed inside the channel member 210. Communication holes 72 of the third channel member 70 communicate with respective holes of the joint rubbers 100 and fluidly communicate with the liquid supply units 220. Multiple communication holes 61 are formed in bottom surfaces of the common channel grooves 62 of the second channel member 60 and communicate with one ends of dedicated channel grooves 52 of the first channel member 50. Communication holes 51 are formed at the other ends of the dedicated channel grooves 52 in the first channel member 50 and the dedicated channel grooves 52 fluidly communicate with the multiple ejection modules 200 via the communication holes 51. Through these dedicated channel grooves 52, the channels can be gathered toward the center side of the channel member 210.

The first to third channel members are preferably made of a material that has corrosion resistance to liquid and a low linear expansion coefficient. As an example of a material, a composite material (resin material) may be favorably used in which alumina, liquid crystal polymer (LCP), polyphenyl sulfide (PPS), or polysulfone (PSF) is used as a base material and inorganic fillers such as silica microparticles or fibers are added. As a method of forming the channel member 210, the three channel members may be stacked and bonded together. In a case where a resin composite material is selected as the material, a joining method by welding may be used.

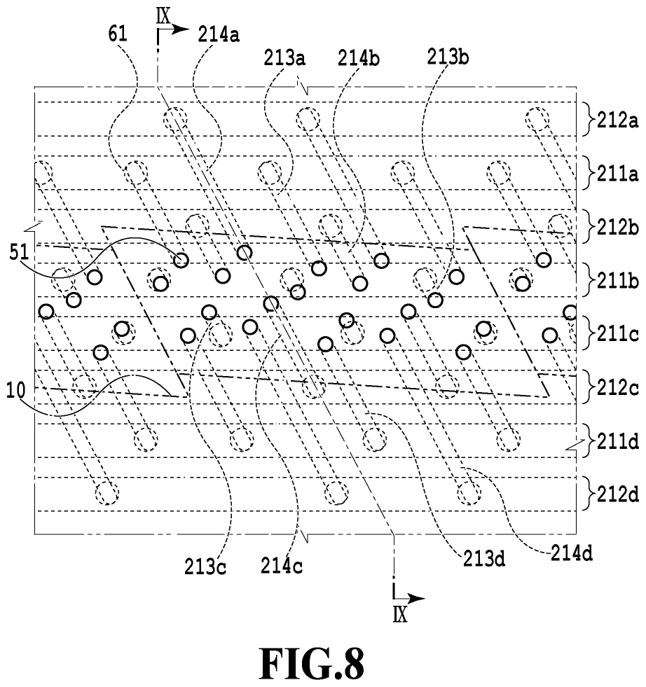

FIG. 8 is an enlarged see-through view illustrating a portion of the channels in the channel member 210 formed by joining the first to third channel members, seen from the surface of the first channel member 50 on which the ejection modules 200 are mounted. Hereinafter, a connection relationship among the channels in the channel member 210 is described. In the channel member 210, for each color, the common supply channel 211 (211a, 211b, 211c, or 211d) and the common collection channel 212 (212a, 212b, 212c, or 212d) are provided which extend in the longitudinal direction of the liquid ejection head 3. The common supply channel 211 for each color is connected via the communication holes 61 to multiple dedicated supply channels 213 (213a, 213b, 213c, or 213d) formed by the dedicated channel grooves 52. The common collection channel 212 for each color is connected via the communication holes 61 to multiple dedicated collection channels 214 (214a, 214b, 214c, or 214d) formed by the dedicated channel grooves 52. With this channel structure, the inks can be gathered from all the common supply channels 211 via the dedicated supply channels 213 to the print element boards 10 located on the center portion of the channel member 210. In addition, the inks can be collected from the print element boards 10 via the dedicated collection channels 214 to all the common collection channels 212.

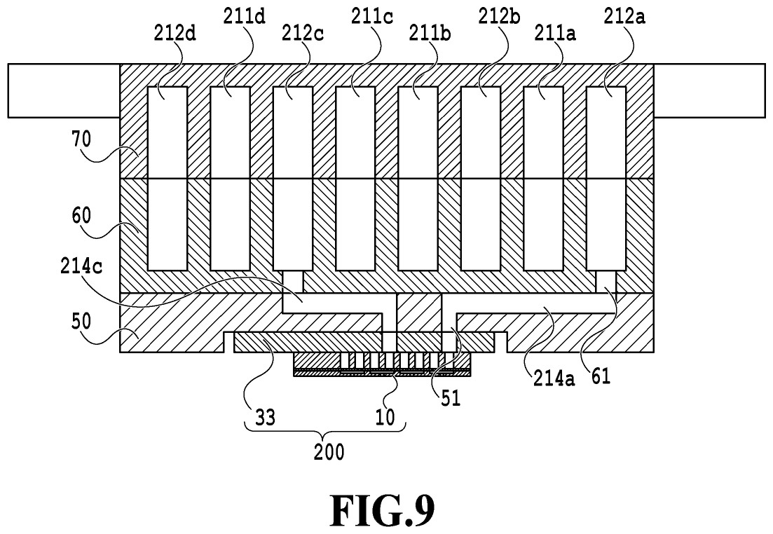

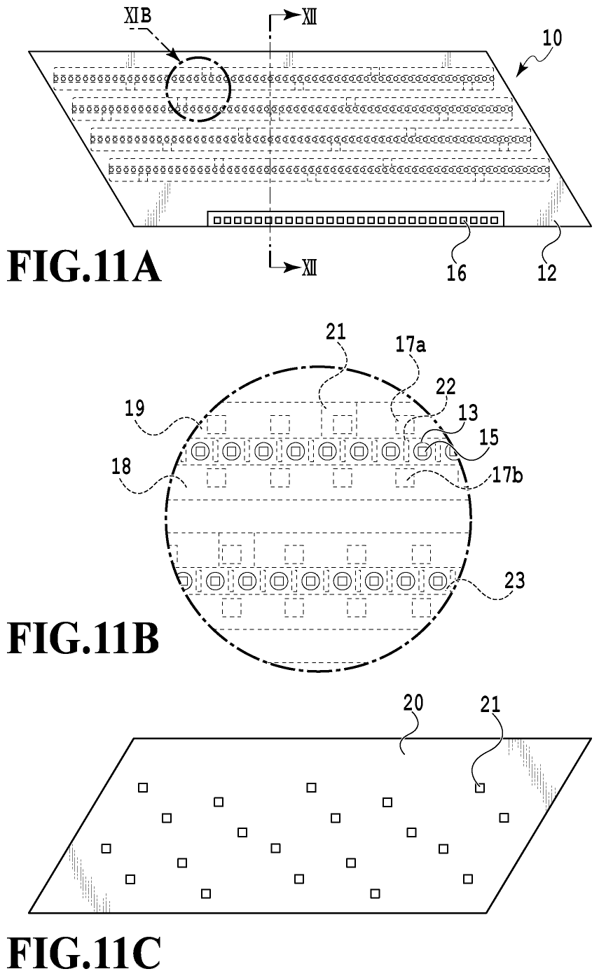

FIG. 9 is a view illustrating a cross section taken along a line IX-IX in FIG. 8. As illustrated in FIG. 9, the dedicated collection channels (214a and 214c) communicate with the ejection module 200 via the communication holes 51. Although FIG. 9 only illustrates the dedicated collection channels (214a and 214c), the dedicated supply channels 213 communicate with the ejection module 200 in another cross section as illustrated in FIG. 8. In a support member 33 and the print element board 10 included in each ejection module 200, channels are formed to supply the inks from the first channel member 50 to print elements 15 (see FIG. 11B) provided to the print element board 10. In the support member 33 and the print element board 10, channels are also formed to return (circulate) portions or all of the inks supplied to the print elements 15 to the first channel member 50. Here, the common supply channel 211 for each color is connected to the negative pressure control unit 230 (high pressure side) for that color via the liquid supply units 220, while the common collection channel 212 is connected to the negative pressure control unit 230 (low pressure side) via the liquid supply units 220. This negative pressure control unit 230 generates a differential pressure (pressure difference) between the common supply channel 211 and the common collection channel 212. Thus, as illustrated in FIGS. 8 and 9, in the liquid ejection head in which the channels are connected together, a flow for each color is generated such that the ink flows from the common supply channel 211 to the dedicated supply channels 213a, the print element boards 10, the dedicated collection channels 214b, and the common collection channel 212 in this order.

FIG. 10A is a perspective view illustrating one ejection module 200 and FIG. 10B is an exploded view of the ejection module 200. As a method of producing the ejection module 200, first the print element board 10 and the flexible wiring board 40 are bonded onto the support member 33 in which liquid communication holes 37 are formed in advance. After that, terminals 16 on the print element board 10 and terminals 41 on the flexible wiring board 40 are electrically connected to each other by wire bonding, and then the wire bonding portion (electric connection portion) is covered and sealed with the seal member 110. Terminals 42 on the flexible wiring board 40 on the side opposite to the print element board 10 are electrically connected to connection terminals 93 (see FIG. 6) of the electric wiring board 90. The support member 33 is a supporting body that supports the print element board 10 and also functions as a channel member through which the print element board 10 and the channel member 210 fluidly communicate with each other. For this purpose, the support member 33 preferably has a high degree of flatness and can be joined to the print element board 10 with sufficiently high reliability. A material for the support member 33 is preferably, for example, alumina or resin material.

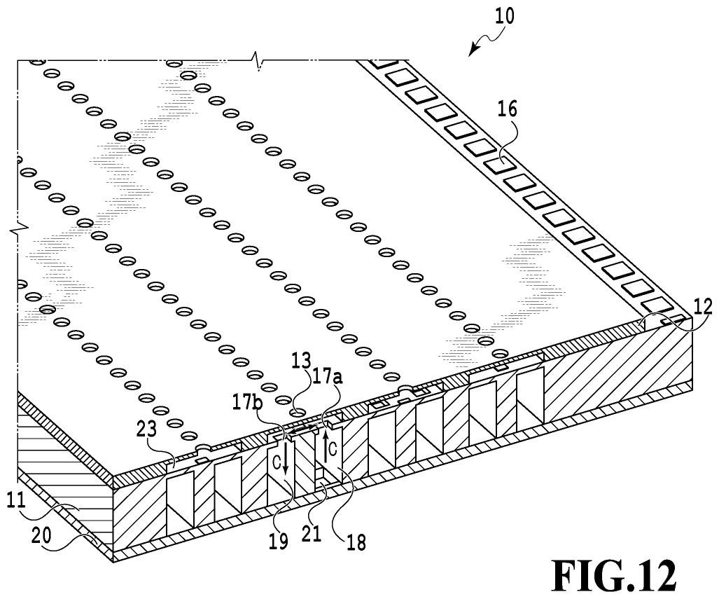

FIG. 11A is a plan view of the surface of the print element board 10 in which the ejection orifices 13 are formed, FIG. 11B is an enlarged view of a portion XIb in FIG. 11A, and FIG. 11C is a plan view of the back side in FIG. 11A. FIG. 12 is a perspective view illustrating a cross section of the print element board 10 and a lid member 20 taken along a cross-section line XII-XII in FIG. 11A. Hereinafter, a structure of the print element board 10 is described.

As illustrated in FIG. 11A, four ejection orifice arrays for the respective colors of inks are formed in an ejection orifice forming member 12 of the print element board 10. Hereinafter, an extension direction of the ejection orifice array in which multiple ejection orifices 13 are arrayed is referred to as an “ejection orifice array direction”.

As illustrated in FIG. 11B, the print element 15 is arranged at a position corresponding to each ejection orifice 13. The print element 15 is a heating element to cause the ink to bubble with thermal energy. A pressure chamber 23 in which the print element 15 is provided is defined by partition walls 22. The print element 15 is electrically connected to the terminal 16 in FIG. 11A via electric wiring (not illustrated) provided to the print element board 10. The print element 15 boils the ink by generating heat based on a pulse signal inputted via the electric wiring board 90 (FIG. 5A) and the flexible wiring board 40 (see FIG. 10B). The force of a bubble generated by this boiling causes the ink to be ejected from the ejection orifice 13. As illustrated in FIG. 12B, along each ejection orifice array, a liquid supply channel 18 extends on one side and a liquid collection channel 19 extends on the other side. The liquid supply channel 18 and the liquid collection channel 19 are channels provided in the print element board 10 and extended in the ejection orifice array direction and communicate with each ejection orifice 13 through a supply port 17a and a collection port 17b, respectively.

As illustrated in FIGS. 11B and 12, the sheet-shaped lid member 20 is laminated on the back surface of the print element board 10 opposite to the surface in which the ejection orifices 13 are formed. In the lid member 20, multiple openings 21 are formed which communicate with the liquid supply channels 18 and the liquid collection channels 19 to be described later. Three openings 21 are provided for one liquid supply channel 18 and two openings 21 are provided for one liquid collection channel 19. As illustrated in FIG. 11C, the openings 21 in the lid member 20 communicate with the multiple communication holes 51 illustrated in FIG. 8 and so on. As illustrated in FIG. 12, the lid member 20 has a function as a lid that forms parts of the walls of the liquid supply channel 18 and the liquid collection channel 19 formed in a substrate 11 in the print element board 10. The lid member 20 preferably has sufficient corrosion resistance to the inks, and the opening shapes and opening positions of the openings 21 are required to achieve high precision from the standpoint of preventing color mixing. For this purpose, it is preferable to use, as a material for the lid member 20, a photosensitive resin material or silicon plate and provide the openings 21 by a photolithography process. Thus, the lid member 20 serves to convert the pitches of the channels by using the openings 21, and therefore it is desirable that the lid member 20 preferably have a small thickness with a pressure drop taken into consideration and be formed of, for example, a film-shaped member.

Next, flows of the inks inside the print element board 10 are described. As illustrated in FIG. 12, in the print element board 10, the substrate 11 formed of Si and the ejection orifice forming member 12 formed of a photosensitive resin are stacked and the lid member 20 is joined to the back surface of the substrate 11. The print elements 15 are formed on one surface side of the substrate 11 (see FIG. 11B), and grooves that form the liquid supply channels 18 and the liquid collection channels 19 extending along the ejection orifice arrays are formed on the back surface side of the substrate 11. The liquid supply channel 18 and the liquid collection channel 19 formed by the substrate 11 and the lid member 20 are connected to the common supply channel 211 and the common collection channel 212 in the channel member 210, respectively, so that a differential pressure is generated between the liquid supply channel 18 and the liquid collection channel 19.

In each ejection orifice 13 not engaged in the ejection operation during printing with the inks ejected from the multiple ejection orifices 13 of the liquid ejection head 3, the ink in the liquid supply channel 18 provided in the substrate 11 flows along arrows C in FIG. 12 due to the above differential pressure. Specifically, the ink flows via the supply port 17a, the pressure chamber 23, and the collection port 17b to the liquid collection channel 19. Through this flow, for example, from the ejection orifice 13 and the pressure chamber 23 not engaged in the printing operation, the thickened ink generated by evaporation through the ejection orifice 13, bubbles, foreign matters, and so on can be collected to the liquid collection channel 19. In addition, this flow can suppress thickening of the ink in the ejection orifice 13 and the pressure chamber 23. The ink collected to the liquid collection channel 19 flows through the openings 21 of the lid member 20 and the liquid communication holes 37 (see FIG. 10B) of the support member 33 and is collected to the communication holes 51, the dedicated collection channels 214, and the common collection channel 212 in the channel member 210 in this order. This ink is eventually collected to the supply path of the printing apparatus 1000.

In sum, the inks supplied from the printing apparatus main body to the liquid ejection head 3 are supplied and collected by flowing in the following order. The inks first flow from the liquid connection portions 111 of the liquid supply units 220 to the inside of the liquid ejection head 3. Then, the inks are supplied to the joint rubbers 100, the communication holes 72 and the common channel grooves 71 provided in the third channel member 70, the common channel grooves 62 and the communication holes 61 provided in the second channel member 60, the dedicated channel grooves 52 and the communication holes 51 provided in the first channel member 50 in this order. After that, the inks are supplied to the pressure chambers 23 via the liquid communication holes 37 provided in the support member 33, the openings 21 provided in the lid member 20, and the liquid supply channels 18 and the supply ports 17a provided in the substrate 11. Of the inks supplied to the pressure chambers 23, the inks not ejected from the ejection orifices 13 flow through the collection ports 17b and the liquid collection channels 19 provided in the substrate 11, the openings 21 provided in the lid member 20, and the liquid communication holes 37 provided in the support member 33 in this order. Thereafter, the inks flow through the communication holes 51 and the dedicated channel grooves 52 in the first channel member 50, the communication holes 61 and the common channel grooves 62 provided in the second channel member 60, the common channel grooves 71 and the communication holes 72 provided in the third channel member 70, and the joint rubbers 100 in this order. Moreover, the inks flow out to the outside of the liquid ejection head 3 from the liquid connection portions 111 provided in the liquid supply units 220. In the mode of the first circulation path illustrated in FIG. 3, the inks flowing in from the liquid connection portions 111 are supplied to the joint rubbers 100 after passing through the negative pressure control units 230. In the mode of the second circulation path illustrated in FIG. 4, the inks collected from the pressure chambers 23 pass through the joint rubbers 100 and then flow to the outside of the liquid ejection head 3 from the liquid connection portions 111 via the negative pressure control units 230.

In addition, as illustrated in FIGS. 3 and 4, not all of the ink flowing from the one end of each common supply channel 211 in the liquid ejection unit 300 is supplied to the pressure chambers 23 via the dedicated supply channels 213a. A portion of the ink flows out from the other end of the common supply channel 211 to the liquid supply unit 220 without entering the dedicated supply channels 213a. In the case where a path through which the ink flows without entering the print element boards 10 is provided as described above, it is possible to suppress a backflow of the circulating flow of the ink even if the liquid ejection head 3 is provided with the print element boards 10 including fine channels with high flow resistance. Therefore, the liquid ejection head 3 can suppress thickening of the ink in the vicinity of the pressure chambers and the ejection orifices, thereby suppressing a deviation of an ejection direction from a proper direction and non-ejection, which results in achievement of high-quality printing.

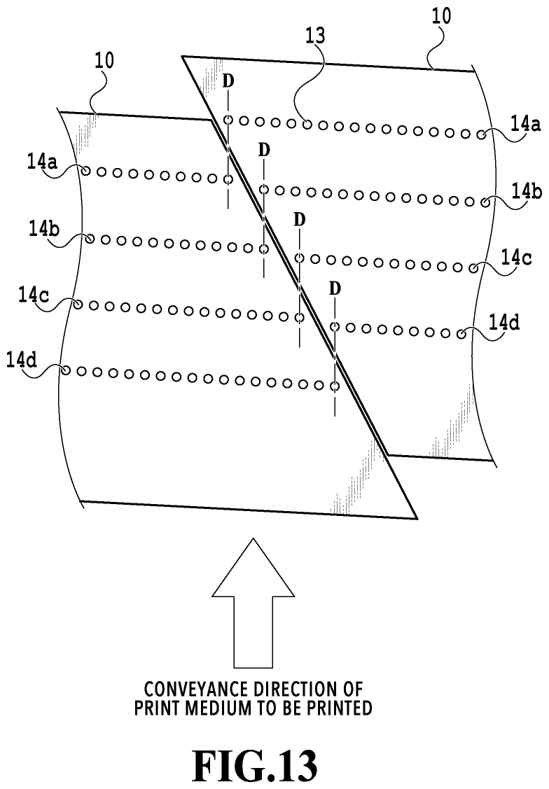

FIG. 13 is an enlarged plan view partially illustrating adjacent portions of the print element boards 10 in the two adjacent ejection modules. As illustrated in FIG. 11A and others, the print element boards 10 in a substantially parallelogram shape are used. As illustrated in FIG. 13, each of the ejection orifice arrays (14a to 14d) in which the ejection orifices 13 are arrayed in each print element board 10 is inclined at a predetermined angle with respect to the print medium conveyance direction. As a result, at least one ejection orifice in each ejection orifice array in one of the adjacent portions of the print element boards 10 overlaps at least one ejection orifice in the corresponding ejection orifice array in the other adjacent portion in the print medium conveyance direction. In FIG. 13, two ejection orifices on each D line overlap each other. With this arrangement, even if the positions of the print element boards 10 are slightly misaligned from predetermined positions, black streaks or white spots that may appear in a printed image can be made less visually-noticeable by driving control of the overlapping ejection orifices. Also in the case where the multiple print element boards 10 are arranged in a linear pattern (in-line) instead of the staggered pattern, a structure as in FIG. 13 may be obtained. This structure makes it possible to prevent black streaks or white spots at the joint area between the print element boards 10 while suppressing an increase in the length of the liquid ejection head 3 in the print medium conveyance direction. Here, the principle planes of the print element boards 10 are each formed in a substantially parallelogram shape, but their shape is not limited to this. For example, even in a case where print element boards in a rectangular, trapezoidal or other shape are used, the structure can be preferably applied.

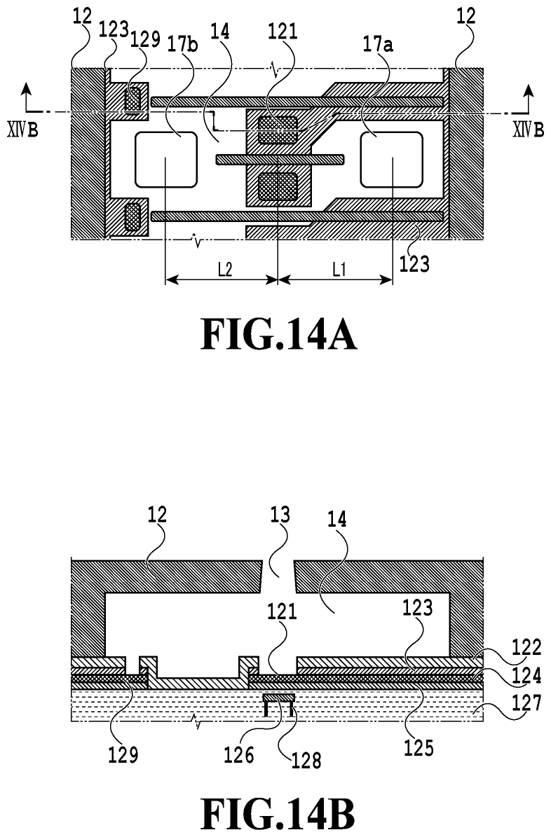

FIG. 14A is an enlarged plan view schematically illustrating an area near a heating portion of the print element board 10, and FIG. 14B is a cross-sectional view taken along a dash-dot line XIVb-XIVb in FIG. 14A. Hereinafter, a structure of the heating portion in the print element board according to the present embodiment is described.

In the liquid ejection head 3, a substrate for liquid ejection printing is formed by stacking multiple layers on a base substrate (not illustrated) made of silicon. In the present embodiment, a thermal storage layer (not illustrated) formed of a thermal oxide film, a SiO film, a SiN film, or the like is disposed on the base substrate. Then, a heating resistor 126 is disposed on the thermal storage layer and is connected via a tungsten plug 128 to an electrode wiring layer (not illustrated, formed in an underlying layer of an insulating protective layer 127 in FIG. 14B) as wiring formed of a metal material such as Al, Al—Si, or Al—Cu. The heating resistor 126 generates heat with power supplied via the electrode wiring layer not illustrated. Generating the heat, the heating resistor 126 causes film boiling of the ink in a bubbling chamber 14 and resultantly causes the ink to be ejected from the ejection orifice 13.

As illustrated in FIG. 14B, the heating resistor 126 is covered with the insulating protective layer 127. The insulating protective layer 127 is an insulating layer provided also on top of the heating resistor 126 so as to cover the heating resistor 126. The insulating protective layer 127 is formed of a SiO film, a SiN film, or the like.

Three protective layers for insulating the insulating protective layer 127 from contact with the liquid are formed on the insulating protective layer 127. The three protective layers include a lower protective layer 125, an upper protective layer 124, and an adhesive protective layer 123, and protects the surface of the heating resistor 126 from chemical and physical shocks associated with heat generation of the heating resistor 126.

In the present embodiment, the lower protective layer 125 is formed of tantalum (Ta), the upper protective layer 124 is formed of iridium (Ir), and the adhesive protective layer 123 is formed of tantalum (Ta). The protective layers formed of these materials are electrically conductive. An adhesive protective layer 122 for improving the liquid resistance and the adhesion to the ejection orifice forming member 12 is provided on the adhesive protective layer 123. The adhesive protective layer 122 is formed of SiC. At a position opposed to the heating resistor 126, the adhesive protective layer 122 is not disposed, and the upper protective layer 124 is exposed to the inside of the pressure chamber 23 and functions as a portion for protecting the heating resistor 126. This area functions as a heating portion during the ejection operation. The upper protective layer 124 is formed of a material containing a metal that is dissolvable through an electrochemical reaction and that will not form a dissolution-preventive oxide film under heating.

The upper protective layer 124 in the heating portion is in contact with the liquid. In ejection of the liquid, the liquid instantaneously rises in temperature to cause cavitation in which a bubble is generated and collapsed. For this reason, in the present embodiment, the upper protective layer 124 formed of an iridium material having high corrosion resistance and high reliability is arranged at the position in contact with the liquid.

In the present embodiment, the pressure chamber 23 employs an ink circulation structure in which the liquid is supplied from the supply port 17a and is collected to the collection port 17b. Accordingly, during printing, the liquid flows on the heating resistor 126 in the direction from the supply port 17a on the upstream side to the collection port 17b on the downstream side.

In the present embodiment, a kogation suppression process for keeping kogation from accumulating on the upper protective layer 124 above the heating resistor 126 is performed in addition to a conventional kogation removal process. This kogation suppression process can be performed during liquid ejection.

Kogation is generated with particles in the ink heated by the heating resistor 126 during ejection. As the ejection is repeated, kogation accumulates on the surface of the upper protective layer 124, which acts as the heating portion during ejection. The particles in the ink which may cause kogation are electrically charged, but the polarity of the charge varies depending on a type of the particles. In general, among particles in inks, coloring material particles such as pigment particles tend to be negatively charged, while metal particles or the like tend to be positively charged. Thus, the polarity of the charged particles which may cause kogation varies depending on the type of the particles.

The following description is given by using, as an example, the printing apparatus 1000 that ejects an ink containing a negatively charged pigment. To explain in detail the kogation suppression process in the present embodiment, an area of the upper protective layer 124 right above the heating resistor 126 is used as a cathode electrode 121, and an area of the upper protective layer 124 located away from the electrode 121 is used as an anode electrode 129. With this structure, negatively charged particles of a pigment and so on are repelled by the cathode electrode 121, decreasing their presence rate in the vicinity of the electrode 121. As a result, kogation may be kept from accumulating on the electrode 121 during printing. In this way, the presence rate of a coloring material, an additive, and so on, which may cause kogation, in the vicinity of the surface of the upper protective layer 124 above the heating resistor 126 is decreased, thereby making it possible to suppress the occurrence of kogation.

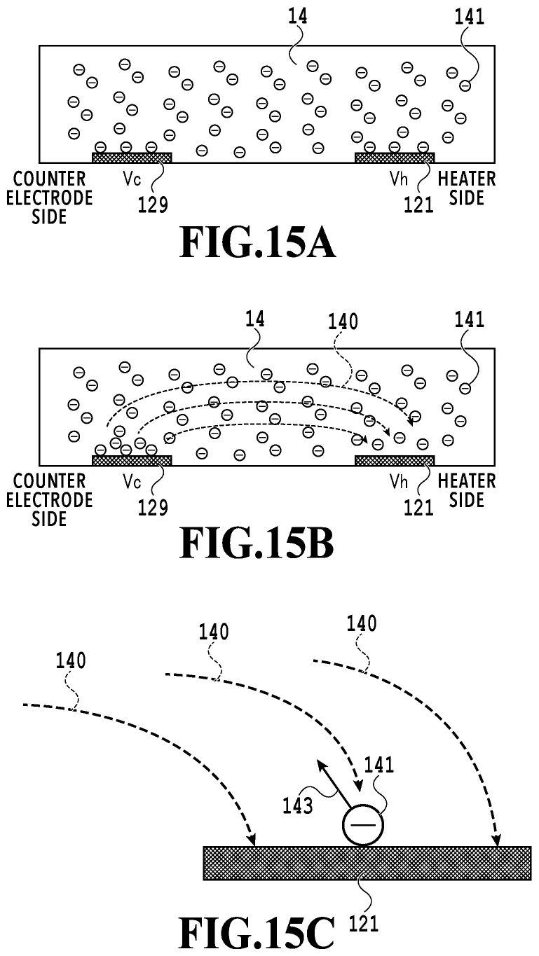

FIGS. 15A to 15C are schematic diagrams illustrating the kogation suppression process in a case where a dominant cause for kogation in the bubbling chamber 14 is negatively charged particles. Hereinafter, a potential control mechanism used in the present embodiment is described by using FIGS. 15A to 15C. As illustrated in FIG. 15A, the electrode 121 and the counter electrode 129 of the upper protective layer 124 are arranged in the bubbling chamber 14 and the bubbling chamber 14 is filled with a liquid (ink). The liquid contains negatively charged particles 141 of a pigment and so on, and the particles 141 are dispersed substantially uniformly in the liquid.

FIG. 15B illustrates a state where a voltage is applied so as to make the potential of the electrode 121 lower than the potential of the counter electrode 129. A potential difference between the electrode 121 and the counter electrode 129 is preferably in a range of 0.5 V to 2.5 V. In this state, an electric field 140 is formed between the electrode 121 and the counter electrode 129 via the liquid but no electric current flows. Since the electrode 121 has a negative potential relative to the counter electrode 129, the negatively charged particles 141 are repelled by the electrode 121 and the presence rate of the particles 141 in the vicinity of the surface of the electrode 121 is decreased. FIG. 15C is an enlarged schematic diagram of the vicinity of the electrode 121 illustrated in FIG. 15B. The negatively charged particle 141 receive a repulsive force 143 along electric field lines of the electric field 140 formed in the liquid, and move away from the electrode 121.

The repulsive force acting on the particles 141 becomes greater as the potential difference ΔV(=Vc−Vh) becomes larger, where Vc denotes the potential of the counter electrode 129 and Vh denotes the potential of the electrode 121 on the heating resistor 126 (heater) side. In other words, as the potential difference ΔV is increased, the presence rate of the negatively charged particles 141, which may cause kogation, in the vicinity of the electrode 121 is decreased and accordingly the amount of accumulated kogation is reduced.

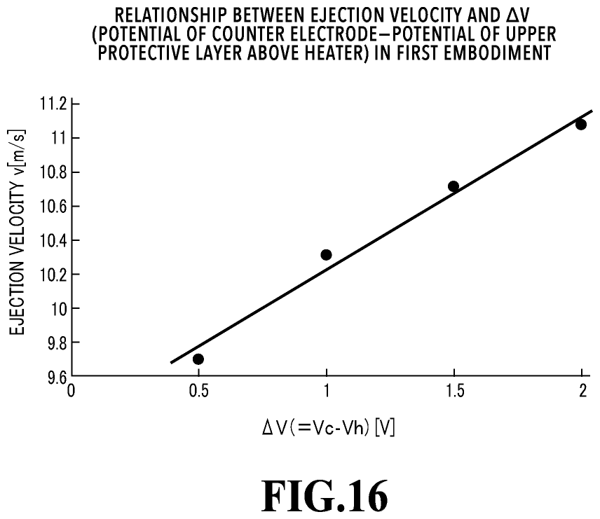

FIG. 16 is a graph presenting a relationship between an ejection velocity and a potential difference ΔV. The ejection velocity is inversely proportional to the amount of kogation accumulated on the electrode 121, that is, the faster the ejection velocity, the smaller the amount of kogation. The relationship between the potential difference ΔV and the amount of kogation on the electrode 121 can be known from the relationship between the potential difference ΔV and the ejection velocity in the present embodiment as presented in the graph in FIG. 16. In FIG. 16, the larger the potential difference ΔV, the faster the ejection velocity, which teaches that the larger the potential difference ΔV, the smaller the amount of kogation.

The above description is given by using the example in which the ink containing the negatively-shaped pigment is ejected. Instead, in a case where an ink containing positively charged particles is ejected, a voltage may be applied so that electrode 121 acts as an anode electrode and the counter electrode 129 acts as a cathode electrode. In this way, the presence rate of the particles 141, which may cause kogation, in the vicinity of the electrode 121 is decreased, thereby making it possible to suppress the occurrence of kogation.

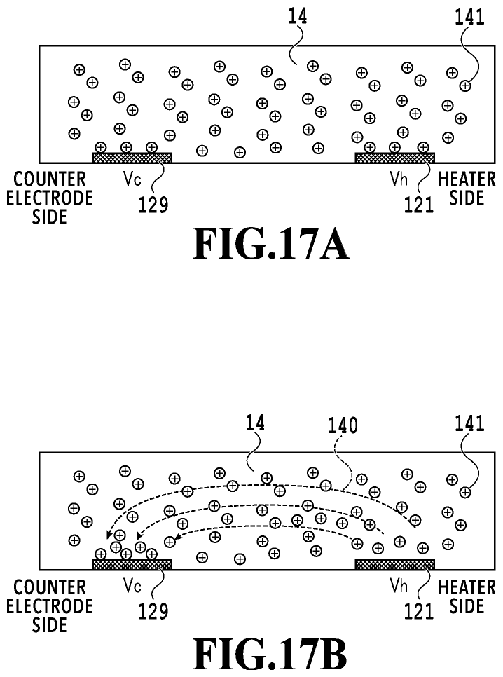

FIGS. 17A and 17B are schematic diagrams illustrating the kogation suppression process in a case where a dominant cause for kogation in the bubbling chamber 14 is positively charged particles. As illustrated in FIG. 17A, the electrode 121 and the counter electrode 129 are arranged in the bubbling chamber 14 and the bubbling chamber 14 is filled with a liquid (ink). The liquid contains positively charged particles 141 of a pigment and so on, and the particles 141 are dispersed substantially uniformly in the liquid in a state where no voltage is applied between the electrodes 121 and 129.

FIG. 17B illustrates a state where a voltage is applied so as to make the potential of the electrode 121 higher than the potential of the counter electrode 129. For example, the potential difference between the electrode 121 and the counter electrode 129 is in a range of 0.5 V to 2.5 V. In this state, an electric field 140 is formed between the electrode 121 and the counter electrode 129 via the liquid. Since the electrode 121 has a positive potential relative to the counter electrode 129, the positively charged particles 141 are repelled by the surface of the electrode 121, and the presence rate of the particles 141 in the vicinity of the surface of the electrode 121 is decreased. The kogation suppression process described herein is a process of generating a potential difference between the electrode 121 and the counter electrode 129, thereby moving charged particles away from the electrode 121 side. A mechanism of such kogation suppression process is described in the specification of, for example, U.S. Pat. No. 8,210,654.

In general, in a state where the surface of the electrode 121 has almost no kogation as in a brand-new liquid ejection head, the surface of the electrode 121 is very susceptible to new kogation in an initial stage of use. It is known that the ejection characteristics change drastically in the initial stage of use due to the above reason. To address this, in a case where a brand-new liquid ejection head is mounted, it is effective to perform an aging process, which is a preliminarily ejection of an ink which will not contribute to printing on paper sheets, thereby making a certain degree of kogation adhere to the surface of the electrode 121. Through execution of the aging process, it is possible to obtain stable ejection characteristics.

On the other hand, in a case where kogation excessively accumulates due to the ejection operations, a kogation removal operation is carried out which includes performing potential control in the liquid ejection head to remove the kogation accumulated on the electrode 121. The kogation removal operation mentioned herein is an operation of applying a voltage so that the electrode 121 acts an anode and the counter electrode 129 acts as a cathode. Through this operation, the electrode 121 is electrochemically dissolved to remove the kogation together with the upper protective layer 124, so that the surface layer of the electrode 121 can be refreshed to an almost brand-new state. Since the kogation removal operation makes the surface of the electrode 121 have almost no kogation, the aging process is performed, as is the case with a brand-new liquid ejection head, after the kogation removal operation.

However, the state of the surface of the electrode 121 of a brand-new liquid ejection head (yet to undergo the kogation removal operation) is not the same as the state of the surface of the electrode 121 having undergone the kogation removal operation. In general, the surface of the electrode 121 is contaminated during manufacturing processes, so that the surface of the electrode 121 in a brand-new state is dirty. On the other hand, since the kogation removal operation is performed by dissolving the upper protective layer 124, the surface of the electrode 121 after the kogation removal operation is not contaminated and is cleaner than in the brand-new state. For this reason, even in the case where the aging process under the same conditions is performed on a brand-new liquid ejection head and a liquid ejection head immediately after execution of the kogation removal operation, the same degree of kogation cannot be formed in these two heads. Specifically, the aging process fails to form an appropriate amount of kogation on the surface of the electrode 121 after the execution of the kogation removal operation. For this reason, the ejection characteristics change abruptly upon accumulation of a certain amount of kogation during ejections after the aging process.

To avoid this, in the present embodiment, the kogation suppression process is executed concurrently with the execution of the aging process. In the kogation suppression process, the potential difference ΔVa between the electrode 121 and the counter electrode 129 is set to different values for the brand-new liquid ejection head and the liquid ejection head having undergone the kogation removal operation. Specifically, the kogation suppression process on a brand-new liquid ejection head is performed by using a potential difference ΔVa₂, whereas the kogation suppression process on the liquid ejection head having undergone the kogation removal operation is performed by using a potential difference ΔVa₁ which is smaller than ΔVa₂. With the above setting, on the liquid ejection head having undergone the kogation removal operation, the effect of the kogation suppression process is reduced, which facilitates formation of kogation in the aging process being executed concurrently. As a result, it is possible to prevent the ejection characteristics of the liquid ejection head having undergone the kogation removal operation from changing abruptly and to obtain the stable ejection characteristics.

In the execution of the aging process on the liquid ejection head having undergone the kogation removal operation, it is desirable to set potential control conditions in the kogation suppression process to optimal conditions depending on an ink. Specifically, since the polarity of charged particles differs depending on a type of particles in an ink, it is desirable to apply a voltage so that the polarities of the electrode 121 and the counter electrode 129 are changed depending on the type of the particles. In addition, the number of particles contained in an ink varies among inks even though the particles contained in the inks are charged with the same polarity. For this reason, the potential difference may be adjusted depending on the number of particles (coloring material concentration). In the present embodiment, the kogation suppression process is performed not only during the aging process but also during a normal printing operation. In this kogation suppression process, an equal potential control voltage is used during the aging process and the normal printing operation.

In the present embodiment, as a method of changing the potential difference ΔVa between the potential of the electrode 121 and the potential of the counter electrode 129, any the potential of any one of the electrode 121 and the counter electrode 129 may be changed, or the potentials of both of the electrodes 121 and 129 may be changed. However, a structure to change the potential difference ΔVa by changing the potential of any one of the electrodes is advantageous in terms of cost because its circuit configuration can be simplified. In addition, it is also possible to employ a mode in which the potential of one of the electrodes is fixed to GND and the potential of the other electrode is changed depending on conditions.

In addition, it is preferable to control the amount of kogation in the aging process by using the number of ejections. Moreover, as a method of determining whether or not the aging process was executed appropriately, there is a method of, for example, printing a test image with a uniform density and checking the density of the output product. In this method, the density may be checked visually or checked by using a density sensor provided in the printing apparatus main body.

In this way, the potential difference between the electrode 121 and the counter electrode 129 is set to different values for the brand-new liquid ejection head and the liquid ejection head having undergone the kogation removal operation. This makes it possible to perform a stable ejection operation in a state where kogation in an amount suitable for an ink is accumulated in advance.

### Second Embodiment

Hereinafter, a second embodiment of the present disclosure is described. Since the basic structure of the present embodiment is the same as that of the first embodiment, a characteristic structure is described below.

The first embodiment is described about the case where the surface of the electrode 121 having undergone the kogation removal operation is cleaner and less susceptible to kogation in the aging process than in the brand-new state. However, there is also a case where the surface of the electrode 121 after the kogation removal operation is more susceptible to kogation than in the brand-new state.

For example, there is a case where kogation unevenly adheres to the surface of the electrode 121 after the kogation removal operation due to incomplete removal of the kogation from the surface of the electrode 121 or a similar case. In such a case, the surface of the electrode 121 is dirtier than in a brand-new liquid ejection head. For this reason, if the aging process is executed using a potential difference equal to the potential difference ΔVa₂, which is used for the brand-new liquid ejection head, or the potential difference ΔVa₁ smaller than the potential difference ΔVa₂, kogation may excessively adhere to the surface of the electrode 121 on which the kogation remains unremoved.

To address this, in the aging process in the present embodiment, the kogation suppression process is performed on the liquid ejection head after the kogation removal operation under the potential control conditions using a potential difference ΔVa₂ which is larger than a potential difference ΔVa₁ to be used for a brand-new liquid ejection head. This makes it possible to perform a stable ejection operation in a state where an appropriate amount of kogation accumulates in advance.

Here, whether or not complete removal of kogation is achieved on the surface of the electrode 121 after the kogation removal operation may be checked by performing printing with such a small number of ejections that the amount of kogation may not affect the ejection velocity, and inspecting the ejection characteristics (such as the ejection velocity). Thus, after printing is performed with such a small number of ejections that the amount of kogation may not affect the ejection velocity and the ejection characteristics are inspected, the aging process may be executed while the kogation suppression process is executed under the potential control according to the degree of kogation removal.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-139904, filed Aug. 21, 2024, which is hereby incorporated by reference herein in its entirety.

What is claimed is:

1. A liquid ejection apparatus on which an ejection unit is mountable,
the ejection unit including
a heating resistor configured to generate heat with power supply, thereby generating energy for ejecting a liquid,
a first electrode provided in a protective portion that covers and protects the heating resistor, and
a second electrode capable of electrically connecting with the first electrode via the liquid,
the liquid ejection apparatus comprising a control unit configured to control the mounted ejection unit, wherein
the control unit is capable of executing an aging process of causing the ejection unit to eject the liquid, thereby accumulating kogation on the first electrode, and a kogation removal process of applying a voltage between the first electrode and the second electrode, thereby dissolving a surface of the first electrode into the liquid and removing the accumulated kogation, and
in the aging process, the control unit sets, as a potential difference applied between the first electrode and the second electrode, different potential differences in a case where the ejection unit has undergone the kogation removal process and a case where the ejection unit is yet to undergo the kogation removal process.

2. The liquid ejection apparatus according to claim 1, wherein
in the aging process, the control unit makes the potential difference applied between the first electrode and the second electrode in the case where the ejection unit has undergone the kogation removal process, smaller than in the case where the ejection unit is yet to undergo the kogation removal process.

3. The liquid ejection apparatus according to claim 1, wherein the potential difference is within a range of 0.5 V to 2.5 V.

4. The liquid ejection apparatus according to claim 1, wherein the control unit sets polarities of the first electrode and the second electrode depending on a type of the liquid.

5. The liquid ejection apparatus according to claim 4, wherein in a case where the liquid contains negatively charged particles, the control unit applies a voltage so that the first electrode acts as a cathode.

6. The liquid ejection apparatus according to claim 4, wherein in a case where the liquid contains positively charged particles, the control unit applies a voltage so that the first electrode acts as an anode.

7. The liquid ejection apparatus according to claim 1, wherein the control unit changes the potential difference between the first electrode and the second electrode depending on a type of the liquid.

8. The liquid ejection apparatus according to claim 1, wherein
the ejection unit is a print head configured to print an image on a print medium by ejecting the liquid, and
a voltage applied to the first electrode and the second electrode in the aging process is equal to a voltage applied to the first electrode and the second electrode in printing on a print medium.

9. The liquid ejection apparatus according to claim 1, wherein
in the aging process, the control unit makes the potential difference applied between the first electrode and the second electrode in the case where the ejection unit has undergone the kogation removal process, larger than in the case where the ejection unit is yet to undergo the kogation removal process.

10. A control method of a liquid ejection apparatus on which an ejection unit is mountable,
the ejection unit including
a heating resistor configured to generate heat with power supply, thereby generating energy for ejecting a liquid,
a first electrode provided in a protective portion that covers and protects the heating resistor, and
a second electrode capable of electrically connecting with the first electrode via the liquid,
the method comprising:
an aging step of causing the ejection unit to eject the liquid, thereby accumulating kogation on the first electrode; and
a kogation removal step of applying a voltage between the first electrode and the second electrode, thereby dissolving a surface of the first electrode into the liquid and removing the accumulated kogation, wherein
in the aging step, as a potential difference applied between the first electrode and the second electrode, different potential differences are set in a case where the ejection unit has undergone the kogation removal step and a case where the ejection unit is yet to undergo the kogation removal step.

11. The control method of a liquid ejection apparatus according to claim 10, wherein polarities of the first electrode and the second electrode are set depending on a type of the liquid.

12. The control method of a liquid ejection apparatus according to claim 11, wherein in a case where the liquid contains negatively charged particles, a voltage is applied so that the first electrode acts as a cathode.

13. The control method of a liquid ejection apparatus according to claim 11, wherein in a case where the liquid contains positively charged particles, a voltage is applied so that the first electrode acts as an anode.
